(19) United States
(12) Patent Application Publication
(10) Pub. No.: US 2011/0285267 A1
(43) Pub. Date: Nov. 24, 2011

(54) SOLID-STATE LIGHT BULB HAVING AN ION WIND FAN AND A HEAT PIPE

(75) Inventors: Wei-Yu Wendy LU, Fremont, CA (US); Scott L. Gooch, San Carlos, CA (US); Wei-Min Jeff Wang, Palo Alto, CA (US)

(73) Assignee: Ventiva, Inc., Santa Clara, CA (US)

(21) Appl. No.: 12/782,602

(22) Filed: May 18, 2010

(51) Int. Cl. H01J 61/52

(52) U.S. Cl. 313/46

(57) ABSTRACT

An ion wind fan can be incorporated into a solid-state lighting device to thermally manage the lighting device. In one embodiment, the lighting device has the approximate shape of an A-series light bulb and an A-series light bulb and includes a bulb body, a bulb cover coupled to the bulb body defining a bulb cavity and one or more light emitting diodes (LEDs) located inside the bulb cavity. The lighting device further includes a heat pipe to transfer heat from the one or more LEDs to one or more heat sinks, and an ion wind fan to generate an airflow in impinging on the one or more heat sinks.

### FIELD OF THE INVENTION

Embodiments of the present invention are directed to thermal management for solid state lighting, and in particular to a solid-state light bulb containing an ion wind fan.

### BACKGROUND

LEDs and other solid-state light devices convert more of their energy usage to heat than to light. Thus, thermal management of solid-state lighting is necessary to avoid overheating the solid-state lighting devices.

Most LED manufacturers manage heat in LED lights by providing an external heat sink that doubles as the body of the LED bulb. The LEDs are then thermally coupled to the heat sink, usually in a highly inefficient mariner and at some distance from the heat sink. Heat sinks are a common passive tool used for thermal management. Heat sinks use conduction and convection to dissipate heat and thermally manage the heat-producing component.

To increase the heat dissipation of a heat sink, a conventional rotary fan or blower fan has been used to move air across the surface of the heat sink, referred to generally as forced convection. One way to integrate a traditional fan into an LED bulb is described in U.S. Pat. No. 7,144,135 to Martin, et al. entitled “LED Lamp Heat Sink.” Conventional fans have many disadvantages when used in consumer electronics products, such as noise, weight, size, and reliability caused by the failure of moving parts and bearings.

A solid-state fan using ionic wind to move air addresses the disadvantages of conventional fans. However, integrating an ion wind fan into an LED bulb poses many challenges.

### BRIEF DESCRIPTION OF THE DRAWINGS

FIG. 1 is a block diagram illustrating an ion wind fan implemented as part of thermal management of an electronic device;

FIG. 2A is a perspective view of one embodiment of an ion wind fan;

FIG. 2B is a widthwise cross-sectional view of the embodiment of the ion wind fan of FIG. 2A;

FIG. 3A is a perspective side-view of a U-shaped heat pipe according to one embodiment of the present invention;

FIG. 3B is a perspective view of a heat sink/heat pipe module according to one embodiment of the present invention;

FIG. 3C is a perspective view of a heat spreader/heat pipe/heat sink module according to one embodiment of the present invention;

FIG. 3D is a perspective view of an LEDs/heat spreader/heat pipe/heat sink module according to one embodiment of the present invention;

FIG. 3E is a cross-sectional view of an LED light bulb including an ion wind fan in combination with the module of FIG. 3D according to one embodiment of the present invention;

FIG. 3F is a cross-sectional perspective view of the LED light bulb of FIG. 3E according to one embodiment of the present invention;

FIG. 4A is a perspective side-view of a V-shaped heat pipe according to one embodiment of the present invention;

FIG. 4B is a perspective view of a heat sink/heat pipe module according to one embodiment of the present invention;

FIG. 4C is a perspective view of a heat spreader/heat pipe/heat sink module according to one embodiment of the present invention;

FIG. 4D is a perspective view of an LEDs/heat spreader/heat pipe/heat sink module according to one embodiment of the present invention;

FIG. 4E is a cross-sectional view of an LED light bulb including an ion wind fan in combination with the module of FIG. 3D according to one embodiment of the present invention;

FIG. 4F is a cross-sectional perspective view of the LED light bulb of FIG. 3E according to one embodiment of the present invention;

FIG. 4G is another cross-sectional perspective view of the LED light bulb of FIG. 3E according to one embodiment of the present invention;

FIG. 5A is a exploded perspective view of an LEDs/heat spreader/heat pipe/heat sink module according to one embodiment of the present invention;

FIG. 5B is a perspective view of the LEDs/heat spreader/heat pipe/heat sink module of FIG. 5A according to one embodiment of the present invention;

FIG. 5C is another perspective view of an LEDs/heat spreader/heat pipe/heat sink module according to one embodiment of the present invention; and

FIG. 5D is a perspective bottom view of an LEDs/heat spreader/heat pipe/heat sink module according to one embodiment of the present invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Example Ion Wind Fan Thermal Management Solution

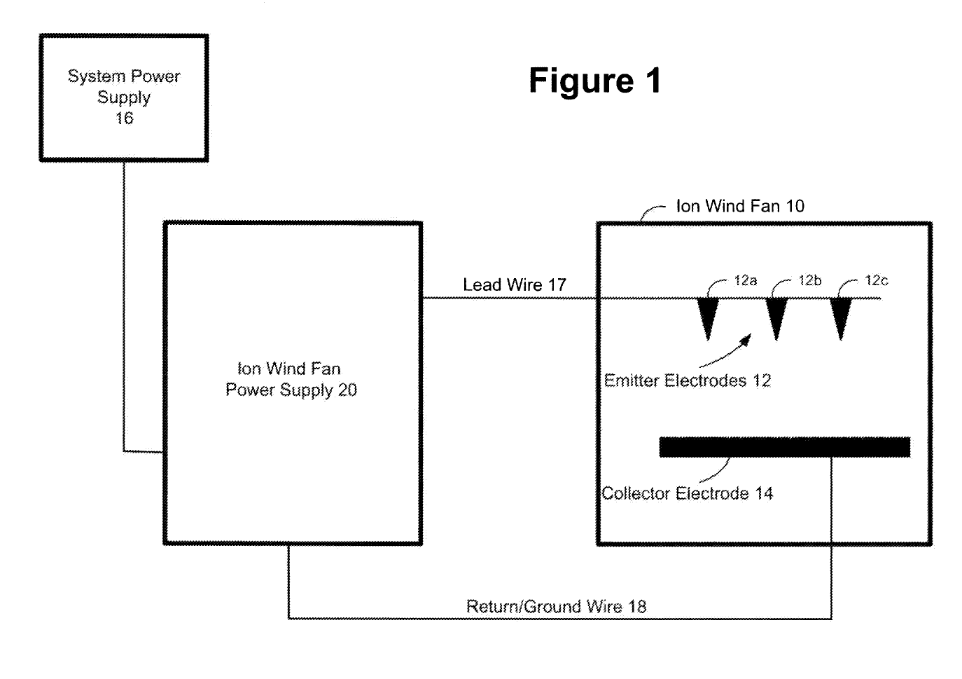

FIG. 1 illustrates an ion wind fan 10 used as part of a thermal management solution for an electronic device. As used in this application, the descriptive term “ion wind fan,” is used to refer to any electro-aerodynamic pump, EHD pump, EHD thruster, corona wind device, ionic wind device, or any other such device used to move air or other gas. The term “fan” refers to any device that move air or some other gas. The term ion wind fan is meant to distinguish the fan from conventional rotary and blower fans. However, any type of ionic gas movement can be used in an ion wind fan, including, but not limited to corona discharge, dielectric barrier discharge, or any other ion generating technique.

An electronic device may need thermal management for an integrated circuit—such as a chip or a processor—that produces heat, or some other heat source, such as a light emitting diode (LED). Some example systems that can use an ion wind fan for thermal management include computers, laptops, gaming devices, projectors, television sets, set-top boxes, servers, NAS devices, memory devices, LED lighting devices, LED display devices, smart-phones, music players and other mobile devices, and generally any device having a heat source requiring thermal management.

The electronic device can have a system power supply 16 or can receive power directly from the mains AC via a wall outlet, Edison socket, or other outlet type. For example, in the case of a laptop computer, the laptop will have a system power supply such as a battery that provides electric power to the electronic components of the laptop. In the case of a wall-plug device such as a gaming device, television set, or LED lighting solution (lamp or bulb), the system power supply 16 will receive the 110V mains AC (in the U.S.A, 220V in the EU) current from an electrical outlet or socket.

The system power supply 16 for such a plug or screw-in device will also convert the mains AC into the appropriate voltage and type of current needed by the device (e.g., 20-50V DC for an LED lamp). While the system power supply 16 is shown as separate from the IWFPS 20, in some embodiments, one power supply can provide the appropriate voltage to both an ion wind fan 10 and other components of the electronic device. For example, a single driver can be design to drive the LEDs of and LED lamp and an ion wind fan included in the LED lamp.

The electronic device also includes a heat source (not shown), and may also include a passive thermal management element, such as a heat sink (also not shown). To assist in heat transfer, an ion wind fan 10 is provided in the system to help move air across the surface of the heat source or the heat sink, or just to generally circulate air (or some other gas) inside the device. In prior art systems, conventional rotary fans with rotating fan blades have been used for this purpose.

As discussed above, the ion wind fan 10 operates by creating a high electric field around one or more emitter electrodes 12 resulting in the generation of ions, which are then attracted to a collector electrode 14. In FIG. 1, the emitter electrodes 12 are represented as triangles as an illustration that they are generally “sharp” electrodes. However, in a real-world ion wind fan 10, the emitter electrodes 12 can be implemented as wires, shims, blades, pins, and numerous other geometries. Furthermore, while the ion wind fan 10 in FIG. 1 has three emitter electrodes (12a, 12b, 12c), the various embodiments of the present invention described herein can be implemented in conjunction with ion wind fans having any number of emitter electrodes 12.

Similarly, the collector electrode 14 is shown simply as a plate in FIG. 1. However, a real-world collector electrode 14 can have various shapes and will generally include openings to allow the passage of air. The collector electrode 14 can also be implemented as multiple collector electrodes (e.g., rods, washers) held at substantially the same potential. Since the specific emitter 12 and collector 14 geometries are not germane to the present invention, they are illustrated as triangles and plates for simplicity and ease of understanding. Furthermore, in a real world ion wind fan 10, the emitter electrodes 12 and the collector electrode 14 would be disposed on a dielectric chassis—sometimes referred to as an isolator element—that has also been omitted from FIG. 1 for simplicity and ease of understanding.

To create the high electric field necessary for ion generation, the ion wind fan 10 is connected to an ion wind power supply 20. The ion wind power supply 20 is a high-voltage power supply that can apply a high voltage potential across the emitter electrodes 12 and the collector electrode 14. The ion wind fan power supply 20 (hereinafter sometimes referred to as “IWFPS”) is electrically coupled to and receives electrical power from the system power supply 16. Usually for electronic devices, the system power supply 16 provides low-voltage direct current (DC) power. For example, a laptop computer system power supply would likely output approximately 5-12V DC, while the power supply for an LED light fixture would likely output approximately 20-70V DC.

The high voltage DC generated by the IWFPS 20 is then electrically coupled to the emitter electrodes 12 of the ion wind fan 10 via a lead wire 17. The collector electrode 14 is connected back to the IWFPS 20 via return/ground wire 18, to ground the collector electrode 14 thereby creating a high voltage potential across the emitters 12 and the collector 14 electrodes. The return wire 18 can be connected to a system, local, or absolute high-voltage ground using conventional techniques.

While the system shown in and described with reference to FIG. 1 uses a positive DC voltage to generate ions, ion wind can be created using AC voltage, or by connecting the emitters 12 to the negative terminal of the IWFPS 20 resulting in a “negative” corona wind. Embodiments of the present invention are not limited to positive DC voltage ion wind. Furthermore, while the IWFPS 20 is shown to receive power from a system power supply 30, in other embodiment, the IWFPS 20 can receive power directly from an outlet.

The IWFPS 20 may include other components. Furthermore, in some embodiments, some of the components listed above may be omitted or replaced by similar or equivalent circuits. For example, the IWFPS 20 is described only as an example. Many different kinds and types of power supplies can be used as the IWFPS 20, including power supplies that do not have a transformers or other components shown in FIG. 1. The components described need not be physically separate, and may be combined on a single printed circuit board (PCB).

As described partially above, ion wind is generated by the ion wind fan 10 by applying a high voltage potential across the emitter 12 and collector 14 electrodes. This creates a strong electric field around the emitter electrodes 12, strong enough to ionize the air in the vicinity of the emitter electrodes 12, in effect creating a plasma region. The ions are attracted to collector electrode 12, and as they move in air gap along the electric field lines, the ions bump into neutral air molecules, creating airflow. On a real world collector electrode 14, air passage openings (not shown) allow the airflow to pass through the collector 14 thus creating an ion wind fan.

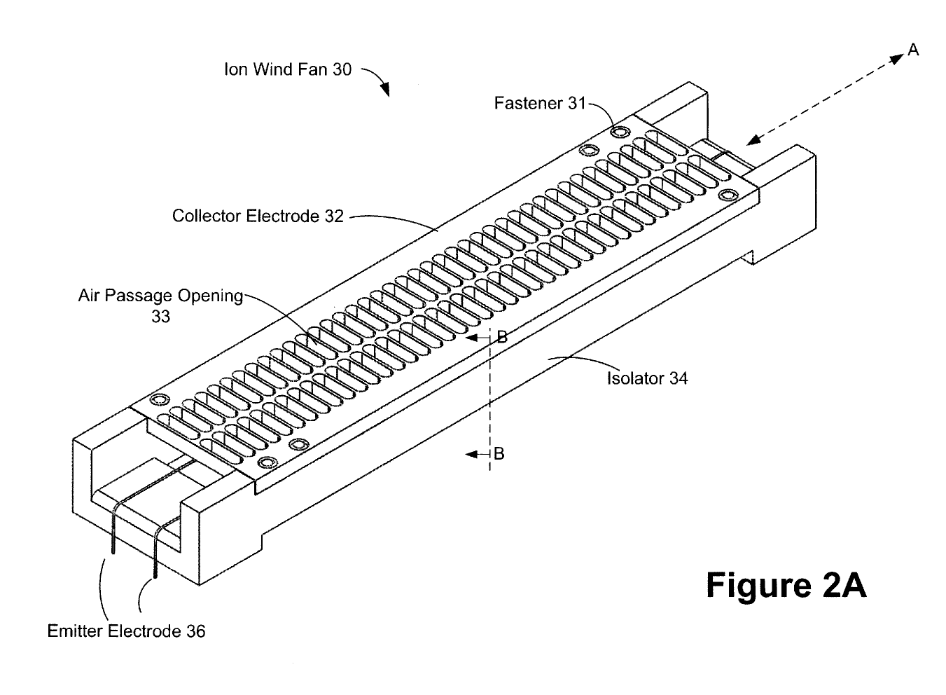

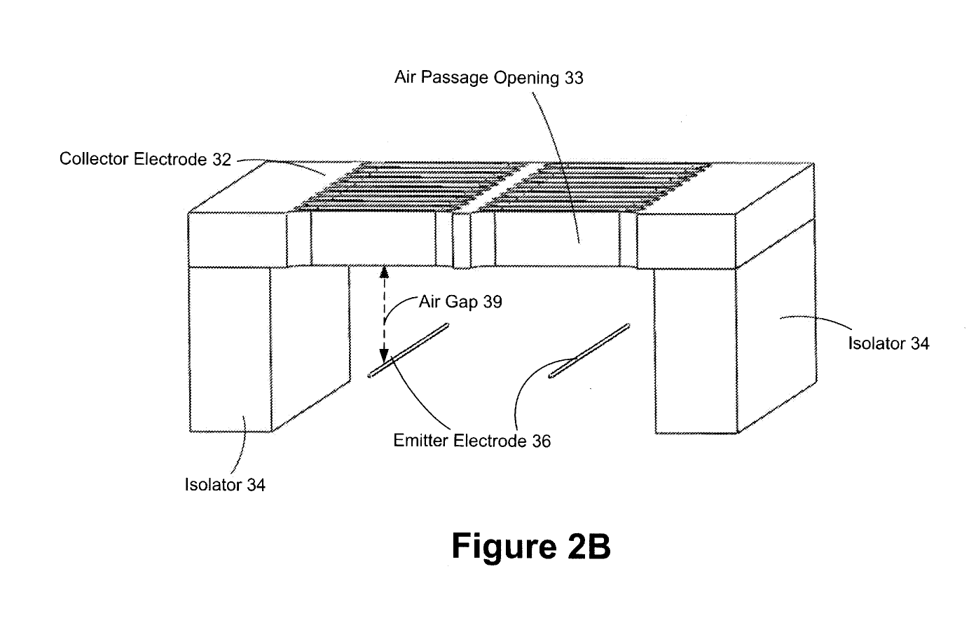

An example of such an ion wind fan is now described with reference to FIGS. 2A and 2B. FIG. 2A is a perspective view of an example ion wind fan 30. The ion wind fan 30 includes a collector electrode 32 having air passage openings 33 to allow airflow. This example ion wind fan 30 has two emitter electrodes 36 implemented as wires, thus implementing what is sometimes referred to as a “wire-to-plane” configuration.

The collector electrode 32 and the emitter electrodes 36 are both supported by an isolator 34. The isolator is made of a dielectric material, such as plastic. The “isolator” component is thusly named as it functions to electrically isolate the emitter electrodes 36 from the collector electrode 32, and to physically support these electrodes and establish the spatial relationship between the electrodes. The isolator 34 can be made from one integral piece—as shown in FIG. 2A—or it can be made of multiple parts and pieces.

In the embodiment shown in FIG. 2A, the collector electrode is attached to the isolator using a fastener 31. The fastener 31 in FIG. 2 is a stake, but any other attachment method can be used, including but not limited to screws, hooks, glue, and so on. Similarly, the particular method of attachment of the emitter electrodes 36 is not essential to the embodiments of the present invention. The emitter electrodes 36 can be glued, staked, screwed, tied, held by friction, or attached in any other way to the isolator 34.

The ion wind fan 30—in the embodiment shown in FIG. 2A—is substantially rectangular in top view. The longitudinal axis of the ion wind fan 30 is denoted with the dotted arrow labeled “A.” The ion wind fan 30 has two ends opposite each other along the longitudinal axis. The emitter electrodes 36 are suspended between the two ends of the ion wind fan 30.

FIG. 2B further illustrates the example ion wind fan 30 shown in FIG. 2A. FIG. 2B is a perspective cross sectional view of the ion wind fan 30 along the line B-B shown in FIG. 2A. The emitter electrodes 36 are suspended in air, and held a substantially constant air gap 39 distance away from the collector electrode 32.

Though wire sag and other emitter irregularities will create some variance, in one embodiment the air gap 39 between the emitter electrodes 36 and the bottom plane of the collector electrode 32 is substantially constant (within a 5% variation). In other embodiments, the air gap 39 can be more variable. The size of the air gap 39 is dependent on the spatial relationship between the electrodes.

The ion wind fan 30 described with reference to FIGS. 2A-B above is just one of many possible types and geometries of ion wind fan that can be used. Various different types of electrodes and isolator configurations are possible. For example, the ion wind fan need not be rectangular in top view; it could be square, circular or oval, cylindrical, and many other shapes. The embodiments of the present invention are not limited to any specific ion wind fan or ionic air pump, and the ion wind fan 30 was described above merely as an example of one possible ion wind fan that can be used.

### Solid State Light Bulbs

While there are various solid-state light devices and semiconductor devices capable of emitting light, such as light-emitting diodes (LEDs), LED arrays, Vertical-cavity surface-emitting lasers (VCSELs), VCSEL arrays, and photon recycling devices among others, the embodiments of the present invention will be described largely with reference to an LED light bulb, as LEDs are currently the most popular device for solid state lighting. However, the embodiments described are not limited to LEDs, and any other solid state or semiconductor light device can be substituted for LEDs in the embodiments described herein.

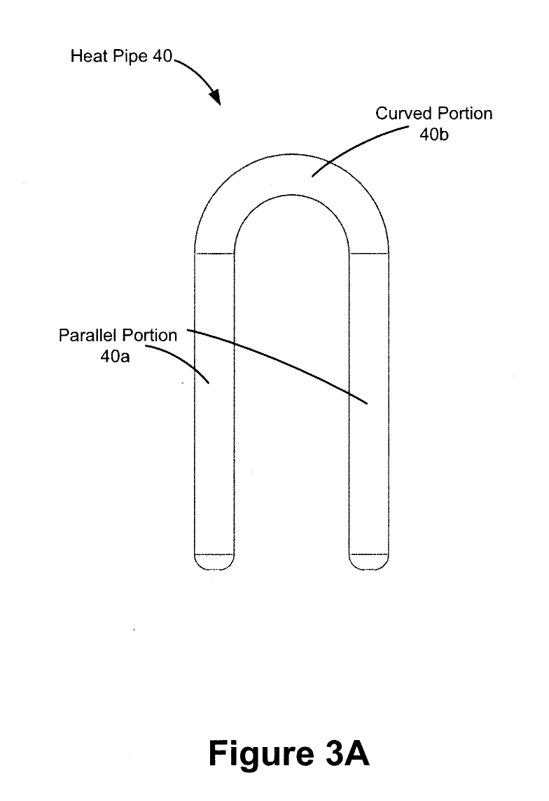

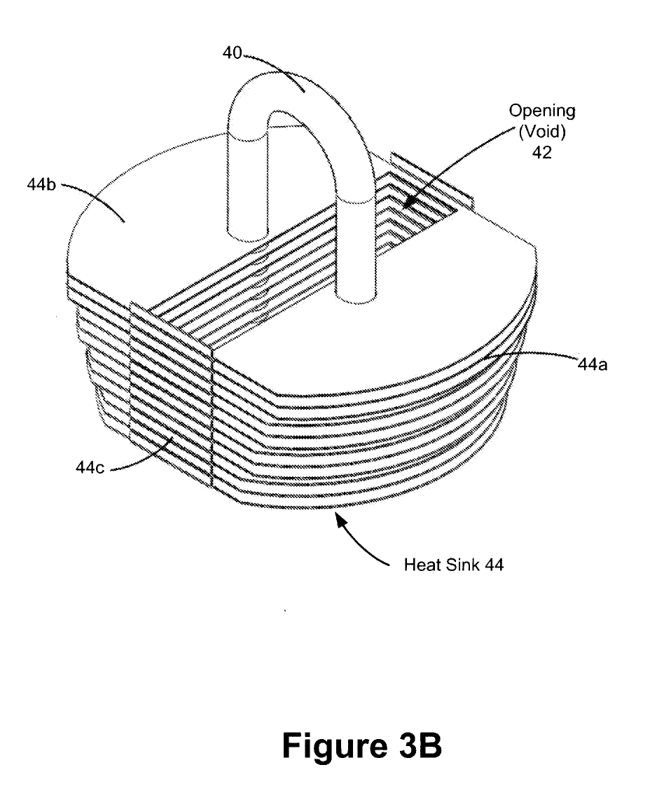

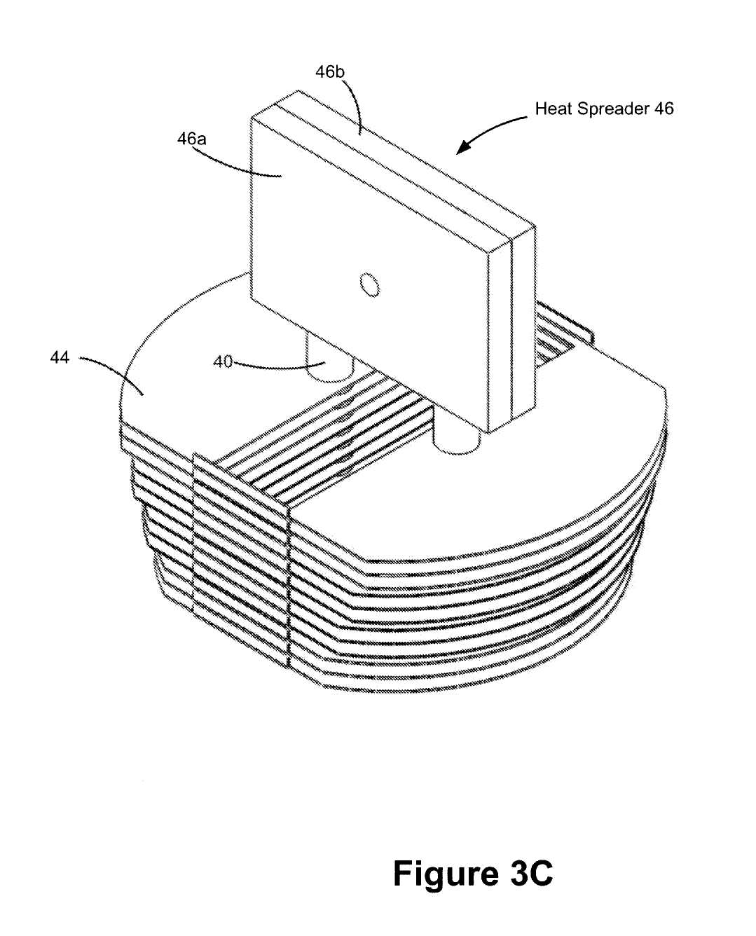

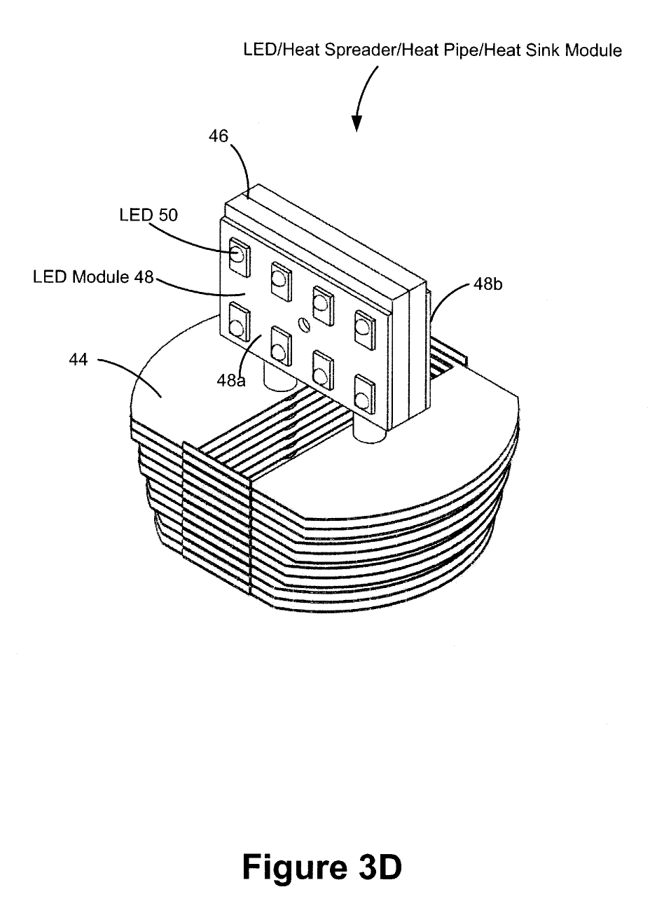

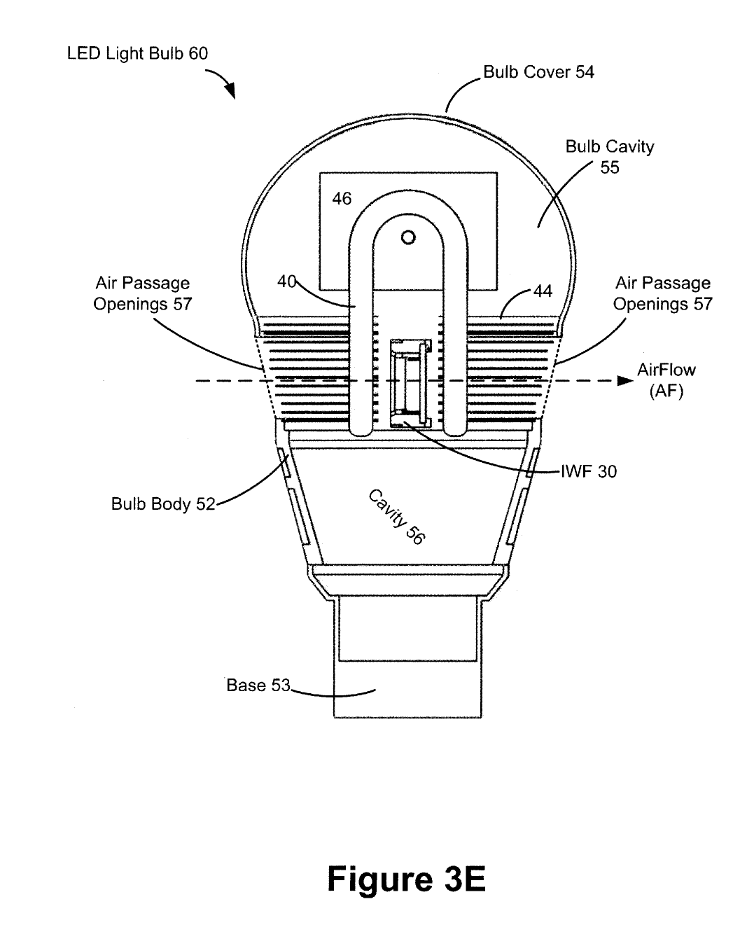

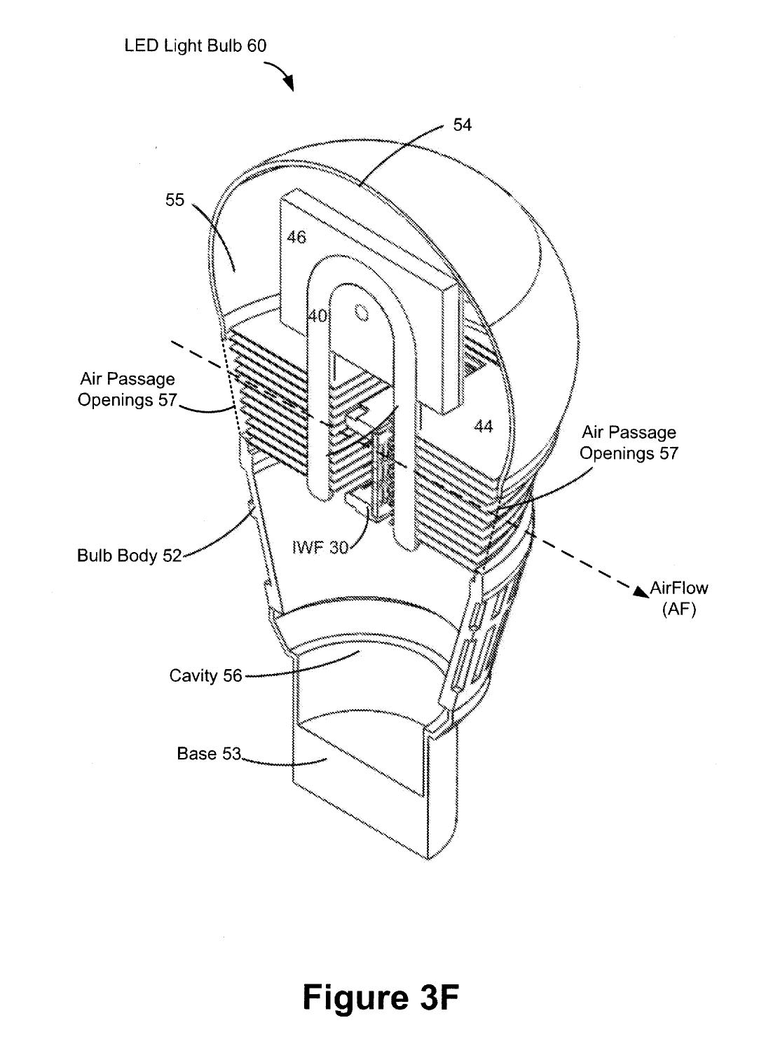

Several embodiments of the present invention are now described with reference to FIGS. 3A-3F. FIG. 3A is a perspective side view of heat pipe 40. The heat pipe 40 has a shape approximately resembling an upside-down upper case “U,” and will be sometimes referred to as a “U-shaped heat pipe.” As such, the heat pipe 40 has two elongated parallel portions 40a that are connected by a rounded or curved portion 40b.

Heat pipes are known heat transfer mechanisms that use both thermal conductivity and phase transition to efficiently effect heat transfer. In one embodiment, the heat pipe is a wick-type heat pipe that uses capillary action to pull a fluid to an evaporation zone, where the fluid evaporates and the steam moves to a condensation zone of the heat pipe. The dimensions of the U-shaped heat pipe 40 will be discussed further below. In one embodiment, the heat pipe 40 has a round cross-section and is approximately 3-7 mm in diameter, although other cross-sectional shapes and diameters can be used.

FIG. 3B is a perspective view of the heat pipe 40 having a heat sink 44 attached to it. The heat sink 44 has two sections 44a, 44b that are each thermally coupled to one of the two elongated parallel portions 40a of the heat pipe 40. Each section 44a, 44b is a fin stack arranged so that the fins extend substantially perpendicular to the direction of the parallel portions of the heat pipe 40, and the planes of the fins are substantially perpendicular to the plane of the heat pipe 40. The number of fins (and the corresponding air passage channels between the fins) and the fin spacing can vary between various embodiments. For example, the two fins stacks shown in FIG. 3B each have 12 fins made of copper, but other materials suitable for heat sinking may be used.

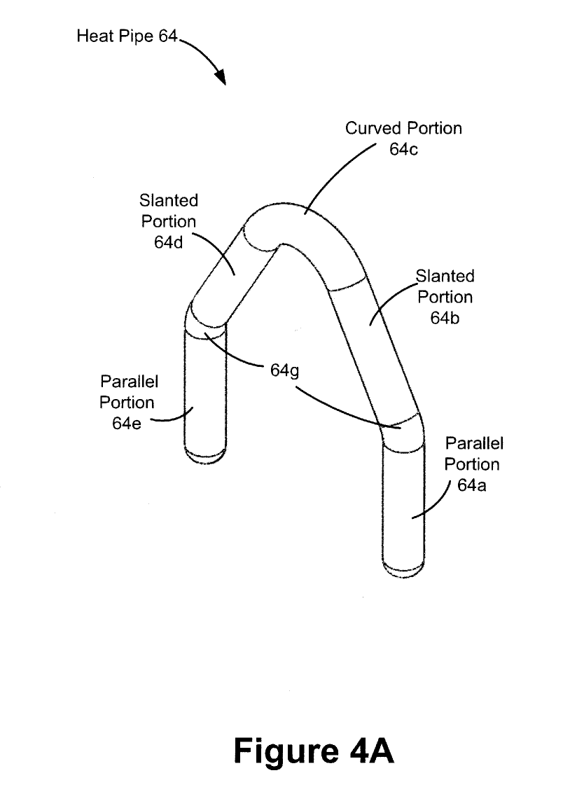

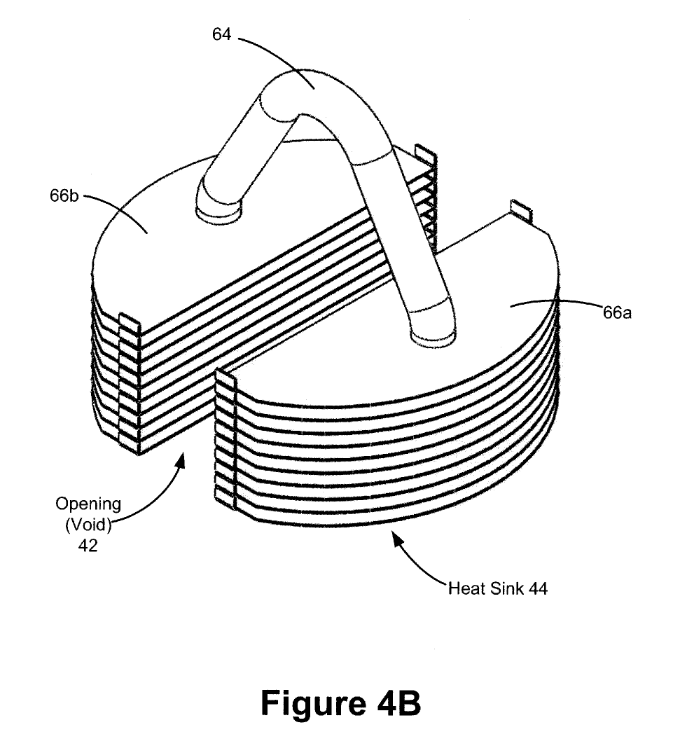

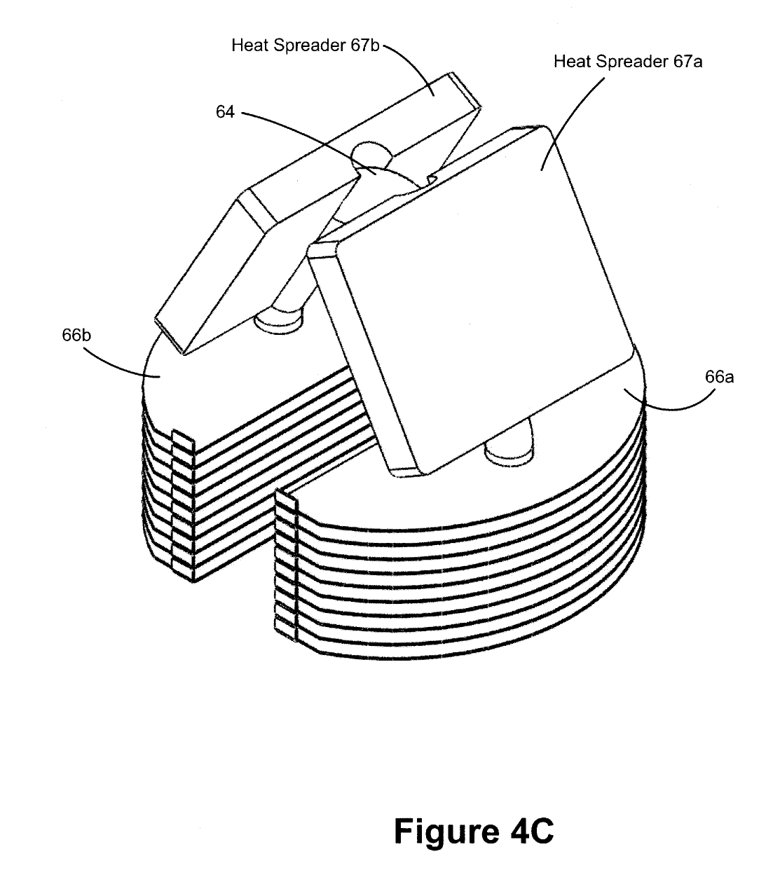

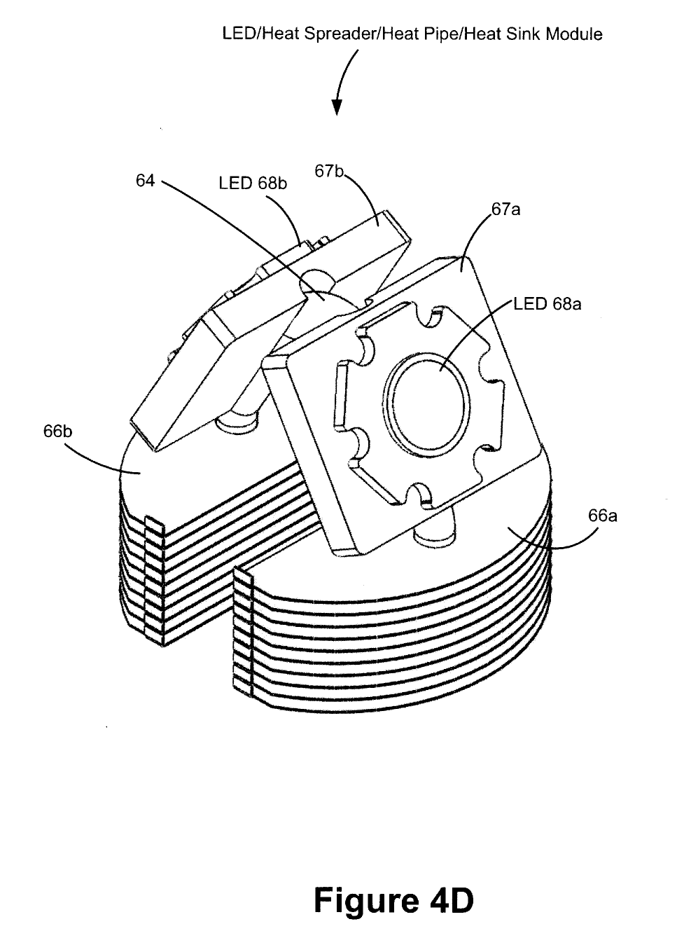

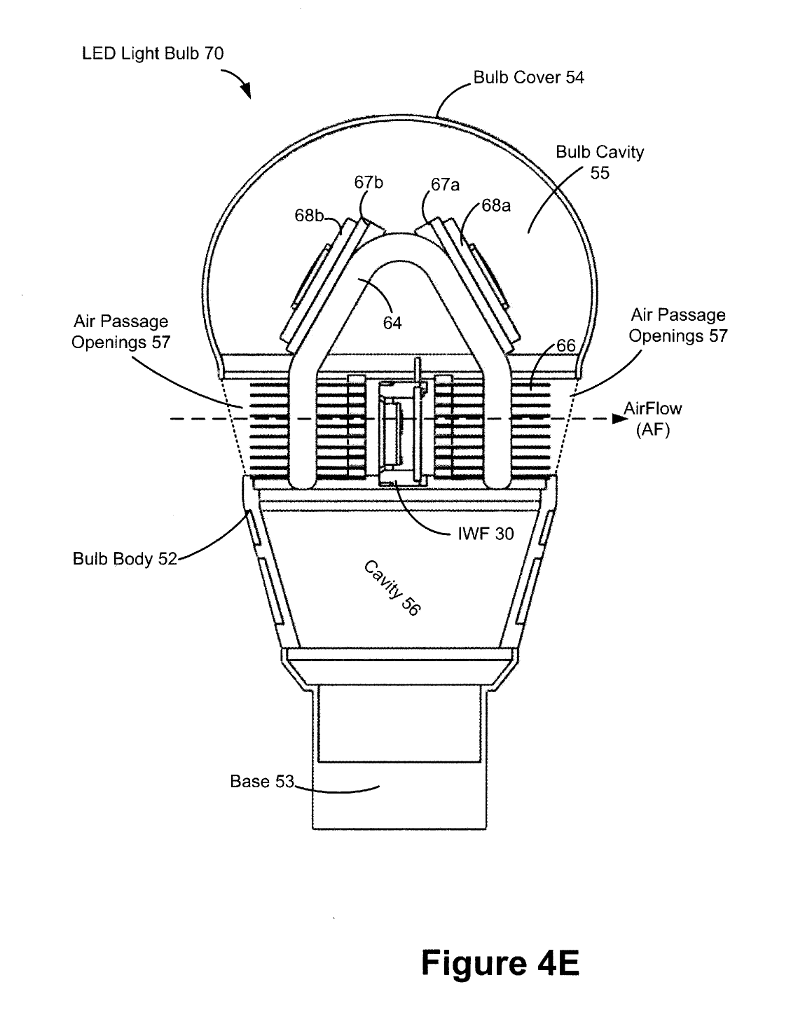

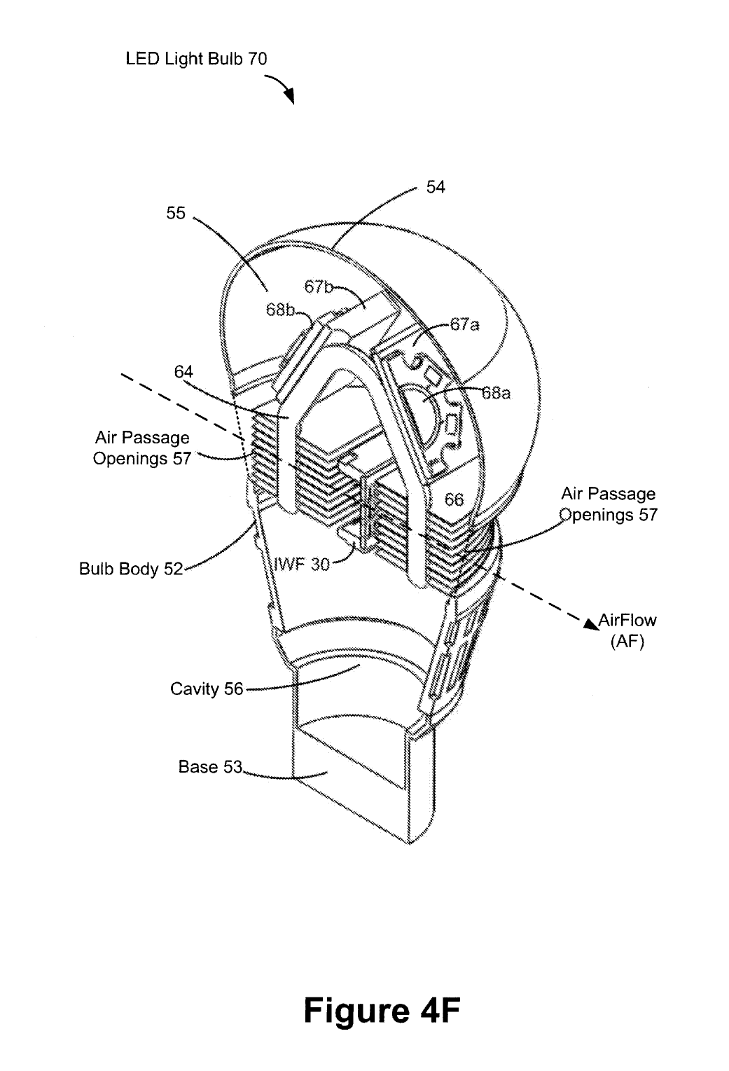

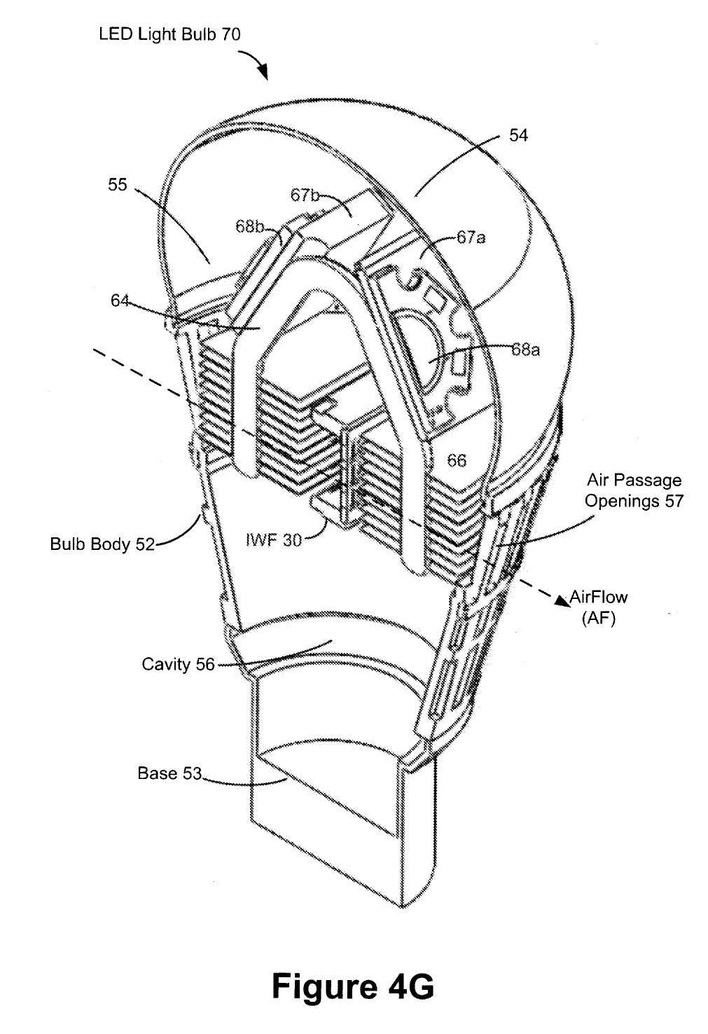

As shown in FIG. 3B, the two sections of the heat sink 44 define an opening 42 between the two parallel portions of the heat pipe 40 and between the two sections of the heat sink. In the embodiment shown in FIG. 3B, this opening 42 has the approximate shape of a rectangular box. As can be seen in FIGS. 2A-C, in one embodiment the ion wind fan 30 has a substantially rectangular box shape. Thus, the opening 42 is configured and designed so that the ion wind fan 30 will fit inside the opening 42. In one embodiment, the two sections are joined by a linking section 44c, although in other embodiments, the two sections 44a, 44b or the heat sink 44 can be separate (as shown for example in FIG. 4B).

FIG. 3C illustrates the addition of a heat spreader 46 to the structure shown in FIG. 3B. The heat spreader 46 is attached to the curved portion 40b of the heat pipe 40. In one embodiment, the heat spreader 46 is made up of two halves 46a, 46b that are coupled together. For example each half 46a and 46b can have a groove in the shape of the heat pipe 40 on its interior surface, so that the heat pipe 40 is surrounded by the heat spreader 46 when the two halves are coupled together as shown in FIG. 3C.

In one embodiment, the heat spreader 46 has the shape of a right cuboid, otherwise known as a rectangular box shape or brick shape. The heat spreader 46 has a “bottom” surface facing the heat sink 44. The parallel portions 40a of the heat pipe 40 protrude from this bottom surface of the heat spreader, in one embodiment.

FIG. 3D illustrates the addition of LED modules 48 to the heat spreader 46. The LED modules 48 are attached to the largest rectangular surfaces of the heat spreader. In other words, the LED modules 48 are oriented in a plane substantially parallel to the plane of the U-shaped heat pipe 40. The LEDs 50 mounted on the LED modules 48 emit light in 180 degrees out of the plane of the LED modules 48. In the embodiment shown, the LED modules 48 each have eight LEDs 50 in two rows, but other numbers and arrangements of LEDs can be used.

The structure shown in FIG. 3D makes up an LED-heat pipe-heat sink construction that can be used in a light bulb. The components of the construction are all thermally coupled—in one embodiment—so that heat generated by the LEDs 50 is transferred via the heat pipe 50 to the heat sink 44 fins. One embodiment of a solid-state light bulb using the LED-heat pipe-heat sink construction of FIG. 3D is now described with reference to FIG. 3E.

FIG. 3E is a cross-sectional view of an LED light bulb 60. The LED light bulb 60 has the approximate form factor of an A-series bulb. The A-series bulb, also sometimes referred to as the A-lamp, is the most common bulb shape for incandescent light bulbs. A-bulbs in the United States range from the A-15 to the A-23, with the A-19 being the most commonly seen (the numerals indicate maximum bulb diameter in ⅛^{th} inches; A-19 is 19/8 inches in diameter). In Europe, the A-55 bulb is similar in proportions to the A-19 bulb.

Current LED bulbs, such as the Panasonic EverLEDs bulb, the Sharp 600 Series LED bulb (DL-L60AL), and the NEC LifeLED's bulb imitate the A-19/A-55 shape but are usually not exactly within the same form factor as incandescent light bulbs. Sometimes these LED bulbs are referred to as an “LED A-Style lamp.” Thus, in one embodiment—as shown in FIG. 3E—the LED light bulb has a form factor that approximates an A-19/A-55 light bulb, and has a maximum height of 110 mm and a maximum diameter of 60 mm. In such an embodiment, the length of the heat pipe 40 will be around 10-15 cm in length. In other embodiments these sizes can have some variation, or other sizes and types of bulbs shapes may be used with heat pipes of various different lengths and diameters.

The LED bulb 60 has a bulb body 52 that is attached to a base 53. The base 53 can be a screw-type base used with Edison sockets or any other type of bulb base size or standard that is now or in the future used to insert light bulbs into light sockets and/or electrically connect light bulbs to mains power. The bulb body 52 and the base 53 are hollow and define a cavity 56 that is needed to house electronics that drive both the LEDs 50 and the ion wind fan 30 (discussed more further below).

As shown, the shape of the bulb body 52 is approximately conical (with a round cross-section), but a shape even more closely resembling A-bulbs can be used. A bulb cover 54 is attached to the bulb body 52. In one embodiment, the bulb cover 54 is the approximate shape of between a half-sphere and ⅔-of a sphere, as shown in FIG. 3E. The bulb cover 54 can be made or glass, plastic, or other materials, and is transparent or translucent to allow the light emitted by the LEDs 50 to illuminate the environment outside of the bulb body 52.

The bulb cover 54 defines a bulb cavity 55, approximately defined as the area inside the truncated sphere of the bulb cover 54. In practice, the hollow cavity of the bulb body 52 and the bulb cavity 55 can be considered one larger cavity, but in this application the bulb cavity 55 will generally refer to the space inside the LED bulb 60 that is covered by the bulb cover 54.

The structure shown in FIG. 3D can be integrated into the LED bulb 60 as shown in FIG. 3E. The U-shaped heat pipe 40 is oriented so that the curved portion 40b faces away from the base 53, so that the curved portion 40b, the heat spreader 46 attached to the curved portion, and the LED modules 48 attached to the heat spreader 46 are situated inside the bulb cavity 55. Since the LEDs 50 are located in the central area of the bulb cavity 55 and because the bulb cover 54 is more than a half-sphere, light from the LED bulb 60 can radiate in approximately 320 degrees, thus approximating the 360 degree light emission from an incandescent bulb.

The heat sink 44 fins are oriented substantially perpendicular to the longitudinal axis (base to top of bulb cover) of the LED bulb 60. An ion wind fan 30, such as the ion wind fan described with reference to FIGS. 2A-C is disposed in the cavity 42 defined by the heat sink 44 between the two parallel portions 40a of the heat pipe 40. With the ion wind fan 30 oriented as shown in FIG. 3E, the ion wind fan 30 generates an airflow substantially parallel to the arrow labeled “AF,” for air flow.

In one embodiment, the air flow is substantially parallel to the channels created by the heat sink fins 44, thereby optimizing the forced convection and heat transfer of the heat sink 44. The bulb body 52 has opening 57 that allow ambient air from outside the bulb body to flow through the LED bulb 60 and out the other side, in the form of the airflow generated by the ion wind fan 30. Since the airflow “AF” flows along a relatively straight path from intake to exhaust openings, flow resistance is minimized.

In one embodiment, the ion wind fan 30 and the LED-heat pipe-heat sink structure can be spatially isolated from the electronics cavity 56. For example, a circular board or plate can separate the two spaces. In such an embodiment, the ion wind fan 30 and the heat pipe 40 can be attached to this plate. From FIG. 3E it can be seen that there are three general cavities inside the LED bulb 60. The electronics cavity 56—shown empty for simplicity and ease of understanding—that houses drive electronics and power supplies for the LEDs 50 and the ion wind fan 30, the bulb cavity 55, and the heat sink cavity—which can be defined as the space inside the LED bulb 60 separating the electronic cavity 56 and the bulb cavity 55.

FIG. 3F is a cross-sectional perspective view of the LED bulb 60 as shown in FIG. 3E. In this embodiment the plate separating the electronics cavity 56 from the heat sink cavity is omitted or simply not shown for simplicity. If the plate is omitted, then the heat sink 44 and the ion wind fan can be attached to the bulb body 52, and the heatpipe 40 can be attached to the heat sink 44. In other embodiments, the heat pipe 40 and the heat sink 44 are thermally coupled, but do not rely on each other for structural support.

One advantage of an ion wind fan is the ability to design one having various form factors. A rectangular shaped ion wind fan having wire emitter electrodes is a highly efficient configuration, that, when combined with the heat pipe-heat sink structure as shown in FIG. 3E and FIG. 3F is able to generate sufficient forced convection for substantial heat removal that far outperforms heat removal available with passive cooling. On the scale of an A-bulb, especially an A-19/A-55 sized bulb, no other current air pumping technology—such as rotary fans or diaphragm pumps—is able to match the size and performance capabilities of the ion wind fan 30 as positioned in FIGS. 3E and 3F.

Another embodiment of the present invention is now described with reference to FIGS. 4A-4G. While similar in many respects to the embodiment shown in FIGS. 3A-F, this embodiment uses a partially V-shaped heat pipe 64—as shown in FIG. 4A—instead of the U-shaped heat pipe 40 of FIG. 3A. FIG. 4A is a perspective view of a heat pipe 64 having two parallel portions (64a, 64e), and two slanted portions (64b, 64d) joined to two parallel portions by two connecting portions 64g.

In one embodiment, the slanted portions 64a, 64e are approximately [XXX] degrees slanted from the parallel portions in the plane of the heat pipe 64. The two slanted portions 64b, 64d are joined together by a curved portion 64c, thus creating one continuous heat pipe 64. In the embodiment shown in FIG. 4A, the heat pipe 64 is approximately contained in one plane, with no portions extending out of the plane of the heat pipe 64, although such configurations are possible in other embodiments.

FIG. 4B illustrates a heat sink 66 thermally coupled to the heat pipe 64. The heat sink has two parts: portion 66a of the heat sink being coupled to parallel portion 64a or the heat pipe and portion 66b of the heat sink being coupled to parallel portion 64e of the heat pipe. The two portions of the heat sink are design with fins having a curved exterior to adapt the heat sink 66 for insertion into an A-lamp form factor.

The two portions of the heat sink 66 also define an opening 65. In one embodiment, the opening 65 has a shape similar to the shape of an ion wind fan 30 and is adapted to receive an ion wind fan 30 into the opening 65. Thus, in FIG. 4B, the opening 30 is approximately rectangular in shape, as the ion wind fan 30 used in this embodiment is approximately rectangular. In other embodiments, both the ion wind fan 30 and the opening 65 between the two halves of the heat sink 66 can have different shapes or form factors.

Depending on the orientation of the ion wind fan 30 inside the opening 65, one of the heat sink portions 66b is the downstream heat sink while the other heat sink portion 66a is the upstream heat sink. The airflow through the bulb body 52 first passes over the downstream heat sink 66b towards the ion wind fan 30, where it is accelerated through the upstream heat sink 66a.

FIG. 4C illustrates the attachment of two heat spreaders 67 to the slanted portions of the heat pipe 64. In the embodiment shown, heat spreader 67a is coupled to slated portion 64b and heat spreader 67b is coupled to slated portion 64d. In one embodiment, the heat spreaders 67 are substantially square-faces blocks including a half-pipe shaped groove adapted to receive the heat pipe 65. In other embodiments, other attachment methods and shapes can be used for the heat spreaders 67.

FIG. 4D illustrates the attachment of an LED module 68 to each of the heat spreaders 67. As shown, LED module 68a is coupled to heat spreader 67a and LED module 68b is coupled to heat spreader 67b. The LED modules 68 can be implemented using one LED, and LED array, or using any other known or future developed LED package. Furthermore, additional optics can be added to the heat spreaders 67 or LED modules 68 to disperse and/or direct the light generated by the LED modules 68.

In the configuration shown in FIG. 4D, the two LED modules 68 (as well as the two heat spreaders) are at approximately 70-80 degrees angle from each other. According to other embodiments, the angle between the LED modules 68 could vary between 20-160 degrees.

FIG. 4E is a cross-sectional view of an LED light bulb 70 using the heat pipe-heat sink-LED combination structure shown in FIG. 4D. The LED light bulb 70 is similar to the LED light bulb 60 described with reference to FIG. 3E. As such, like features and elements are not described again for simplicity and ease of understanding. The main differences between bulb 60 and bulb 70 are the shape of the heat pipe 64, the location of the heat spreaders 67 mounted to the heat pipe 64, and the subsequent orientation of the LED modules 68 inside the bulb cavity 55.

FIGS. 4E and 4G provide cross-sectional perspective views of the LED light bulb 70. The two views are similar, and require little additional explanation. One difference is that, in FIG. 4G, the portion of the bulb body 52 that contains the air passage openings 57 is shown, while that portion is omitted in FIG. 4F (as well as in FIG. 3F) to provide a better view inside the bulb body 52. Depending on the orientation of the ion wind fan 30 inside, one set of air passage openings 57 on one side of the bulb body 52 are air intake openings, while the openings 57 on the upstream side are air exhaust openings. As shown in FIG. 4G, the view is facing the air exhaust openings 57.

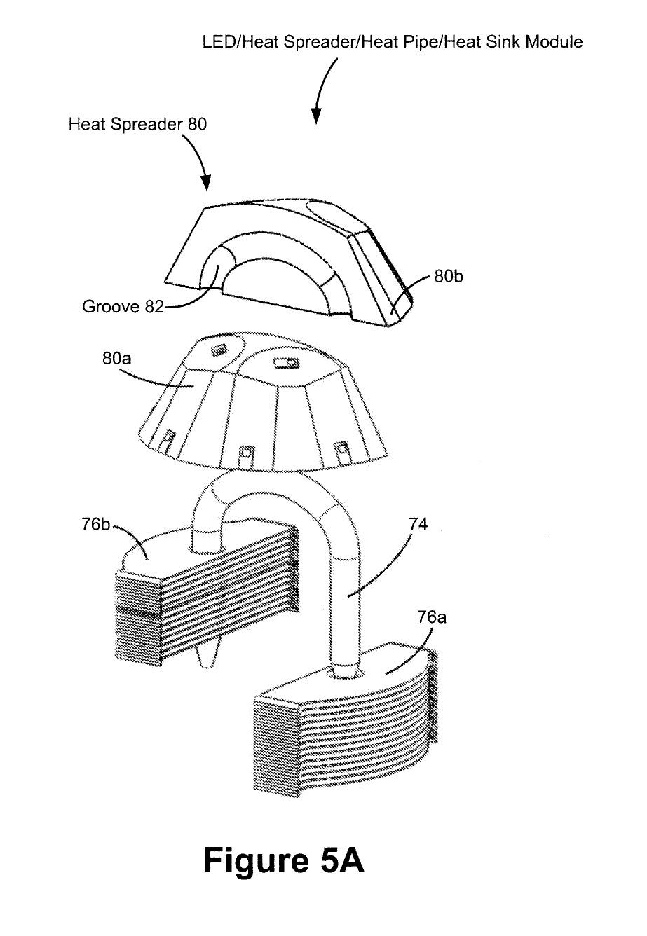

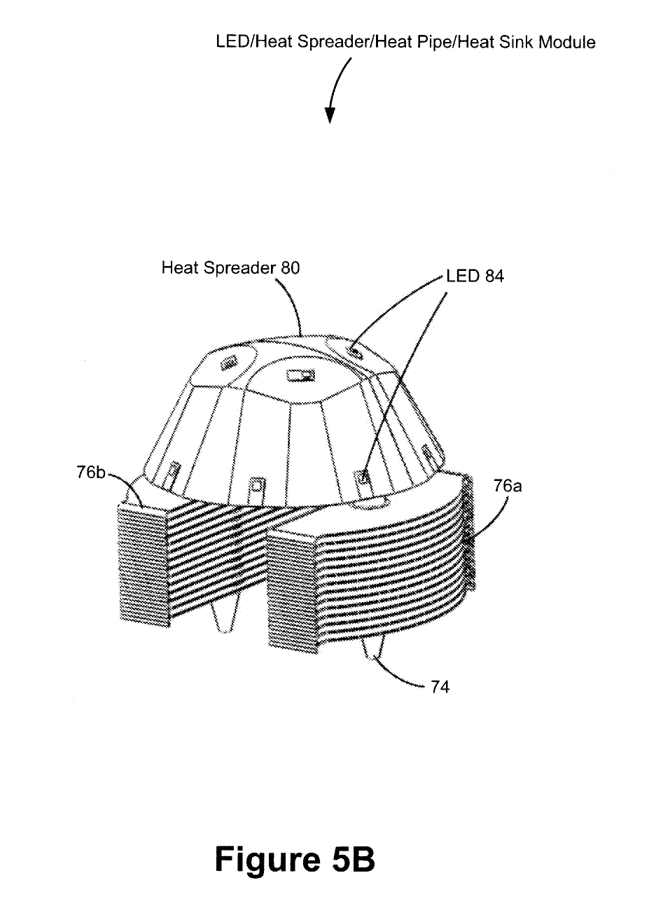

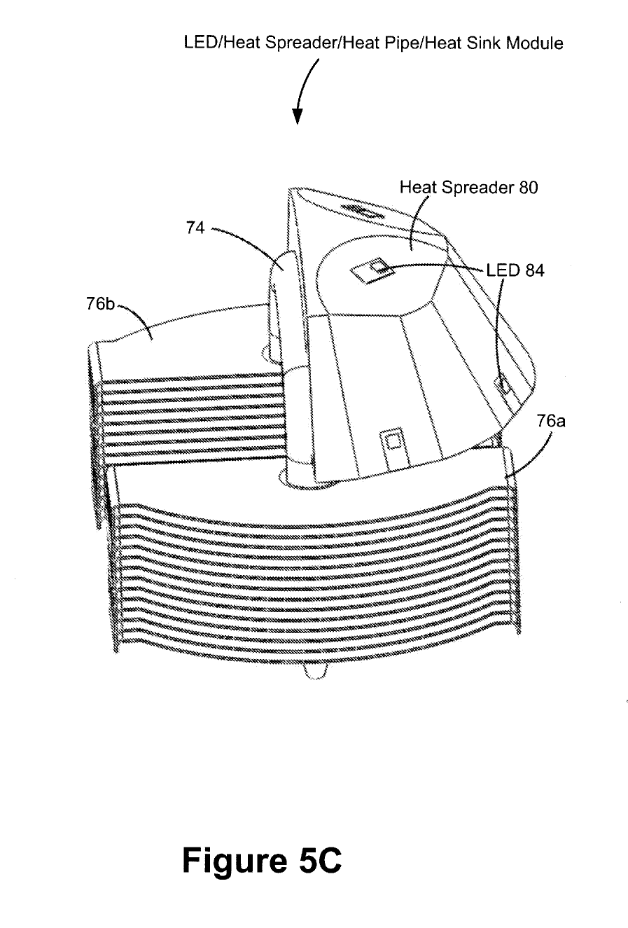

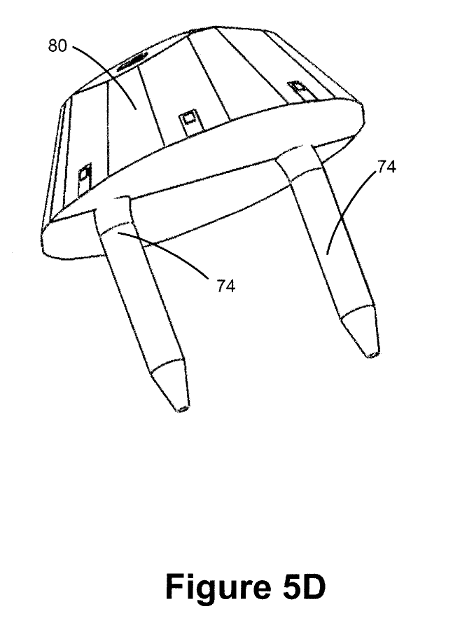

Yet another embodiment of the present invention is now described with reference to FIGS. 5A-5D. The embodiments described with reference to FIGS. 5A-D are similar to the embodiment shown in FIGS. 3A-3F. One difference between the embodiments shown in FIG. 5 and the embodiments shown in FIG. 3 is that in the embodiments described with reference to FIG. 5, the heat spreader on which the LEDs are mounted has the shape of a dome or a polyhedron that approximates a dome-like shape. Technically, the heat spreader can be polyhedron-like and mix straight and curved edges.

FIG. 5A is an exploded view of a heat pipe-heat sink-heat spreader construction, similar to the constructions shown in FIGS. 3C-D and 4C-D. The construction includes a heat pipe 74. The heat pipe 74 can have any of the shapes discussed about with reference to FIGS. 3A and 4A. For example, the heat pipe 74 shown in FIG. 5A is approximately identical to the heat pipe 40 shown in FIG. 3A.

The heat sink 76 having two portions (76a and 76b) each attached to a parallel portion of the heat pipe 74 can also be similar or identical to the equivalent components described above as shown in FIGS. 3B and 4B. In one embodiment, as shown in FIG. 5A, the heat spreader 80 is a quasi-polyhedron that approximates the shape of a half-sphere or dome. In other embodiments, various polyheadra—both regular and otherwise—as well as domes, cones, cylinders, and other rounded shapes can be used.

In one embodiment, the shape of the heat spreader 80 roughly approximates a half sphere (as shown). Since by following the approximate form factor of an A-bulb, the bulb cavity 55 has the approximate shape of a half-sphere, in one embodiment, it can be said that the heat spreader 80 roughly approximates the shape of the bulb cavity 55. Thus, in other embodiments having differently shaped bulb cavities 55, other heat spreader shapes can be used that roughly (or more precisely) approximate those bulb cavities. In yet other embodiment, the shape of heat spreader 80 is designed with only light emission directionality in mind, and the shape of the heat spreader 80 may or may not approximate the shape of the bulb cavity 55.

In one embodiment, the heat spreader 80 is manufactured as two portions (80a and 80b) that are both attached to the heat pipe 74 and to each other. Each heat spreader portion 80a, 80b includes a curved groove 82 that is adapted to receive the heat pipe 74. A perspective view of the assembled module is shown in FIG. 5B. The module (or construction) includes the U-shaped heat pipe 74, the heat sink 76 coupled to the parallel portions of the heat pipe 74, the dome-like heat spreader 80 coupled to the curved potion of the heat pipe 74, and various LEDs or LED modules 84 coupled to the heat spreader. All of these components are thermally coupled so that heat generated by the LEDs 84 is conducted by the heat spreader 80 to the heat sink 76 via the heat pipe 74.

FIG. 5C further illustrates the attachment of the heat spreader 80 to the heat pipe 74 by showing one embodiment of the heat spreader portion 80a attached to the heat pipe 74. FIG. 5D provides further illustration by showing a perspective view of the bottom of the heat spreader 80. The heat sink 76 is omitted for clarity and ease of illustration and understanding. In one embodiment, the bottom surface of the heat spreader 80 is substantially flat, has no LEDs 84 mounted thereon, and includes the openings from which the parallel portions of the heat pipe 74 extend.

The module or construction shown in FIGS. 5A and 5B can be inserted into an LED light bulb in the same or similar manner as shown in FIGS. 3E and 3F for example. The heat spreaders 46 and 80 have been described as being assembled from two portions that are coupled together. However, in other embodiment more than two portions can be used, in addition to a single monolithic structure. In yet other embodiments, the portions of the heat spreaders may not be joined to each other but coupled only to the heat pipe.

In the descriptions above, various functional modules are given descriptive names, such as “ion wind fan power supply.” The functionality of these modules can be implemented in software, firmware, hardware, or a combination of the above. None of the specific modules or terms—including “power supply” or “ion wind fan”—imply or describe a physical enclosure or separation of the module or component from other system components.

Furthermore, descriptive names such as “emitter electrode,” “collector electrode,” and “isolator,” are merely descriptive and can be implemented in a variety of ways. For example, the “collector electrode,” can be a plate-like component with oval air-passage openings (as shown in the Figures), but it can also be made of multiple rods spaced apart, a mesh screen, or in numerous other geometries. The embodiments of the present invention are not limited to any particular kind of collector electrode.

Similarly, the isolator can be the substantially frame-like component shown in the Figures, but it can have various shapes. The electrodes and the isolator are not limited to any particular material; however, the isolator will generally be made of a dielectric material.

As mentioned above, various embodiments of the present invention are applicable to any form of solid-state lighting, even though the embodiments are described in terms of LED lighting for simplicity and ease of understanding. Furthermore, the present invention is not limited to any specific ion wind technology or ion wind fan shape or size.

What is claimed:

1. A lighting device having the approximate shape of an A-series light bulb, the lighting device comprising:
a bulb body;
a bulb cover coupled to the bulb body, the bulb cover defining a bulb cavity,
a first heat sink having a plurality of fins defining a plurality of air passage channels;
a second heat sink having a plurality of fins defining a plurality of air passage channels, the first and second heat sinks being located substantially outside of the bulb cavity;
one or more light emitting diodes (LEDs) located inside the bulb cavity;
a heat pipe configured to transfer heat from the one or more LEDs to the first and second heat sinks; and
an ion wind fan to generate an air flow in the air passage channels.

2. The lighting device of claim 1, wherein the ion wind fan is located between the first heat sink and the second heat sink.

3. The lighting device of claim 1, wherein the bulb body comprises one or more air intake opening and one or more air exhaust openings.

4. The lighting device of claim 3, wherein the air intake openings are located adjacent to the first heat sink and the air exhaust opening are located adjacent to the second heat sink.

5. The lighting device of claim 1, wherein the heat pipe comprises a U-shaped heat pipe having two parallel portions connected by a curved portion.

6. The lighting device of claim 5, wherein the ion wind fan is located between the two parallel portions of the U-shaped heat pipe.

7. The lighting device of claim 1, wherein the first heat sink has a substantially flat internal edge, the internal edge being adjacent to the ion wind fan.

8. The lighting device of claim 1, wherein the first heat sink has an external edge adjacent to the bulb body, the external edge having a shape substantially conforming to the shape of the bulb body.

9. The lighting device of claim 1, wherein the first and second heat sinks each have a substantially flat internal edge defining an opening that is adapted to contain the ion wind fan, and the first and second heat sinks each have a curved external edge adjacent to the bulb body.

10. A solid-state light bulb having a longitudinal axis comprising:
a base at a first end of the solid-state light bulb, the base being adapted to connect the solid-state light bulb to a source of electricity;
a bulb cover defining a bulb cavity at a second end of the solid-state light bulb, the second end being longitudinally opposite the first end, the bulb cavity containing one or more solid-state light devices;
an electronics cavity located between the base and the bulb cavity, the electronics cavity containing electronics to operate the solid-state light devices;
a heat sink having a downstream portion and an upstream portion, the heat sink being located between the electronics cavity and the bulb cavity;
a heat pipe thermally coupled to the heat sink, the heat pipe configured to conduct heat from the solid-state light devices to the heat sink; and
an ion wind fan located between the downstream portion of the heat sink and the upstream portion of the heat sink, wherein the ion wind fan generates an airflow that impinges on the heat sink.

11. The solid-state light bulb of claim 10, further comprising a heat spreader thermally coupled to the heat pipe, wherein the solid-state light devices are coupled to the heat spreader.

12. The solid-state light bulb of claim 11, wherein the heat spreader comprises a right cuboid having solid-state light devices attached to two or more sides of the right cuboid.

13. The solid-state light bulb of claim 11, wherein the heat spreader has a substantially dome-like shape.

14. The solid-state light bulb of claim 11, wherein the heat spreader has a shape approximating the shape of the bulb cavity.

15. The solid-state light bulb of claim 11, wherein the heat pipe comprises two parallel portions oriented in the longitudinal direction and a curved portion, the curved portion connecting the two parallel portions.

16. The solid-state light bulb of claim 15, wherein the heat spreader is coupled to the heat pipe at the curved portion of the heat pipe.

17. The solid-state light bulb of claim 11, wherein the heat pipe comprises two parallel portions oriented in the longitudinal direction and two slanted portions, the slanted portions being parallel neither to the parallel portions nor to each other.

18. The solid-state light bulb of claim 17, wherein the heat spreader is coupled to the heat pipe at one of the two slanted portions of the heat pipe.

19. The solid-state light bulb of claim 18, further comprising a second heat spreader, wherein the second heat spreader is coupled to the heat pipe at the other one of the two curved portion of the heat pipe.

20. The solid-state light bulb of claim 10, wherein the airflow generated by the ion wind fan is substantially perpendicular to the longitudinal direction.

21. The solid-state light bulb of claim 10, wherein the solid-state light devices comprise light-emitting diodes (LEDs).
